(19) United States
(12) Patent Application Publication
(10) Pub. No.: US 2021/0009422 A1
(43) Pub. Date: Jan. 14, 2021

(54) CARBON PURIFICATION METHOD AND CARBON PRODUCT

(71) Applicant: Agency for Science, Technology and Research, Singapore (SG)

(72) Inventors: Ming Lin, Singapore (SG); Yuanting Karen Tang, Singapore (SG); Hui Teng Casandra Chai, Singapore (SG); Ziyi Zhong, Singapore (SG); Ji Zhong Luo, Singapore (SG)

(73) Assignee: Agency for Science, Technology and Research, Singapore (SG)

(21) Appl. No.: 17/041,664

(22) PCT Filed: Mar. 25, 2019
(86) PCT No.: PCT/SG2019/050162

§ 371 Date: Sep. 25, 2020

(30) Foreign Application Priority Data
Apr. 12, 2018 (SG) 10201803053W

(51) Int. Cl. C01B 32/17; C01B 32/162

(52) U.S. Cl. CPC C01B 32/17; B82Y 30/00; C01P 2006/80; C01B 32/162

(57) ABSTRACT

A carbon purification method (10) and a carbon product are provided. The carbon purification method (10) includes providing (12) a carbon product having a catalyst content and/or impurities, performing (14) a hydrothermal acid digestion operation on the carbon product in an acid to dissolve the catalyst content and/or the impurities, and performing (16) a filtering operation to separate the dissolved catalyst content and/or the dissolved impurities from the carbon product.

### FIELD OF THE INVENTION

The present invention relates to a carbon purification method and a carbon product produced using the same.

### BACKGROUND OF THE INVENTION

Purification of carbon nanotubes (CNTs) by reduction of catalyst content and removal of impurities is a necessary step for obtaining pure carbon nanotubes. However, purification of carbon nanotubes remains a challenge despite extensive research having been done in this area. Amongst the issues faced is the use of oxidants such as hydrogen peroxide (H₂O₂) and potassium permanganate (KMnO₄) to increase catalyst removal efficiency. The addition of oxidants causes some reactions with the surface of the carbon nanotubes, generating functional groups and destroying the surface of the carbon nanotubes. Other shortcomings of known purification methods include the use of large quantities of acids and long reflux durations. In view of the foregoing, it would be desirable to provide a carbon purification method that can mitigate at least some of these shortcomings.

### SUMMARY OF THE INVENTION

Accordingly, in a first aspect, the present invention provides a carbon purification method. The carbon purification method includes providing a carbon product having a catalyst content and/or impurities, performing a hydrothermal acid digestion operation on the carbon product in an acid to dissolve the catalyst content and/or the impurities, and performing a filtering operation to separate the dissolved catalyst content and/or the dissolved impurities from the carbon product.

In a second aspect, the present invention provides a carbon product produced in accordance with the carbon purification method of the first aspect, the catalyst content of the carbon product being less than 5 wt %.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1 is a flow diagram illustrating a carbon purification method in accordance with an embodiment of the present invention;

FIG. 2A is a transmission electron microscope (TEM) image of a carbon product before purification;

FIG. 2B is a TEM image of the carbon product of FIG. 2A after application of a carbon purification method in accordance with an embodiment of the present invention;

FIG. 3 is a graph showing results of thermal gravimetric analysis (TGA) performed on the carbon products of FIGS. 2A and 2B;

FIG. 4 is a graph showing the distribution of the purified carbon nanotubes (CNTs) of FIG. 2B;

FIG. 5 is a scanning electron microscopy (SEM) image of the carbon product of FIG. 2B; and

FIG. 6 shows a Raman spectrum of the carbon product of FIG. 2B.

### DETAILED DESCRIPTION OF EXEMPLARY EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

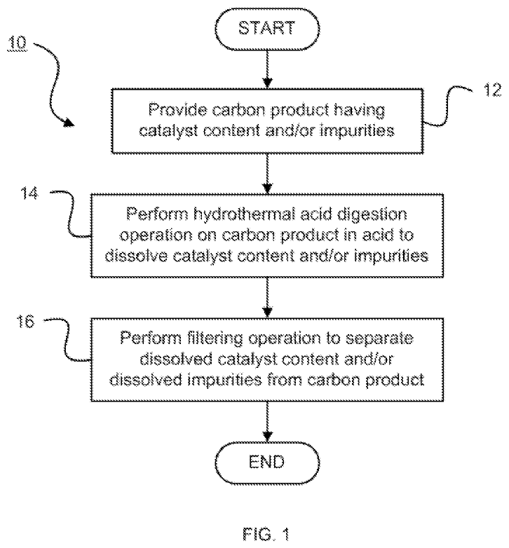

Referring now to FIG. 1, a carbon purification method 10 is shown. The method 10 begins by providing a carbon product having a catalyst content and/or impurities, that is, other non-carbon content, at step 12.

The carbon product may be a plurality of carbon nanotubes. The carbon nanotubes may be grown from natural rubber precursors or hydrocarbon precursors. The as-synthesized carbon nanotubes may contain a catalyst and/or other non-carbon content.

The catalyst content and/or the impurities that are removed from the carbon nanotubes using hydrothermal acid treatment may include one or more of metal catalysts and stable oxide supports. More particularly, the catalyst content may include one or more of a metal and a metal oxide. In one embodiment, the catalyst content may include one or more of iron (Fe), nickel (Ni), aluminium oxide (Al₂O₃) and nickel aluminium oxide (NiAl₂O₄).

At step 14, a hydrothermal acid digestion operation is performed on the carbon product in an acid to dissolve the catalyst content and/or the impurities. The hydrothermal reaction may be used to remove Al₂O₃ and NiAl₂O₄ supports.

The hydrothermal acid digestion operation may be performed in the acid at a temperature that is higher than a boiling point of the acid. In one embodiment, the temperature at which the hydrothermal acid digestion operation is performed may be between about 130 degrees Celsius (° C.) and about 160° C.

All common inorganic mineral acids such as, for example, nitric, sulphuric and hydrochloric acids, may be applied to effectively remove the catalysts from the carbon nanotubes under hydrothermal acid treatment. Different types of inorganic mineral acids may be used standalone without the addition of oxidants for the removal of non-carbon species and/or catalysts on carbon nanotubes via hydrothermal treatment. The hydrothermal acid digestion operation may be performed without addition of an oxidant. In one embodiment, nitric acid may be used effectively alone.

The hydrothermal acid digestion operation may be performed at a pressure of between about 270,000 pascal (Pa) and about 650,000 Pa.

The described hydrothermal technique may be used to efficiently remove all non-carbon species in a shorter time. More particularly, the hydrothermal acid digestion operation may be performed for a period of between about 2 hours (h) and about 12 h.

The hydrothermal acid digestion operation may be performed in an acid solution having a concentration of between about 1 mole per litre (mol/L) and about 5 mol/L. In one embodiment, 30 millilitres (mL) of 5 moles per litre (mol/L) of acid may be used for every 0.5 gram (g) of as-synthesized carbon nanotubes.

The reaction may be carried out in a pressurized vessel, which allows temperature to be above the boiling point of the acid. More particularly, the hydrothermal treatment may be performed in an acid digester which allows the reaction to be pressurized and uses temperature higher than the boiling point of the acid. The hydrothermal acid treatment may be directly applied to the purification process using the acid digester. This provides more energy to the acids for reaction and hence, uses lesser amounts of acids. This also enhances the reaction rate between the acid and a metal or metal oxide containing compound and hence a full removal of catalysts may be achieved with a lesser amount of acid.

A filtering operation is performed at step 16 to separate the dissolved catalyst content and/or the dissolved impurities from the carbon product. Water alone may be used to wash out the remaining residue and to neutralize the purified carbon nanotubes (CNTs).

Between about 95 mass percent (wt %) and about 99 wt % of the catalyst content may be removed with the carbon purification method 10. Accordingly, the catalyst content of the carbon product produced in accordance with the carbon purification method 10 may be less than 5 wt %. The purified carbon nanotubes may have a purity of greater than about 95 mass percent (wt %).

The improved purification technique for carbon nanotubes using hydrothermal acid treatment significantly decreases the amount of acid and time used as compared to the common refluxing method. In particular, this method may significantly decrease the treatment time by four (4) fold as compared to the common refluxing method. The concentration of acid used may be as low as 1 mole per litre (mol/L). The carbon nanotubes may be effectively purified at a temperature of 140 degrees Celsius (° C.) in 8 hours (h), regardless of the type of acid used. In one embodiment, raw carbon nanotubes may be effectively purified to a purity of greater than about 95 wt % with 5M nitric acid at 160° C. for 4 hours using hydrothermal acid techniques.

The carbon purification method 10 may be applied as a purification treatment for carbon nanotubes and may be applicable to any carbon products containing metal and metal oxide catalysts.

### EXAMPLES

0.5 grams (g) of as-grown carbon nanotubes (CNTs) was added to 30 millilitres (mL) of 5 molar (M) acid in an acid digester and placed at 140 degrees Celsius (° C.) for various durations. The mixture was then cooled down and filtered using 0.22 micron (μm) pore size filter paper. It was then washed with deionised (DI) water until the filtrate is neutral in pH. The solid was then collected and dried overnight at 120° C. in an oven.

For comparison, the refluxing method was performed as follows: 0.5 g of as-grown carbon nanotubes (CNTs) was added to 100 mL of 5 M acid and refluxed at 120° C. with stirring for 24 hours. The mixture was then cooled down and filtered using 0.22 μm pore size filter paper. It was then washed with DI water until the filtrate is neutral in pH. The solid was then collected and dried overnight at 120° C.

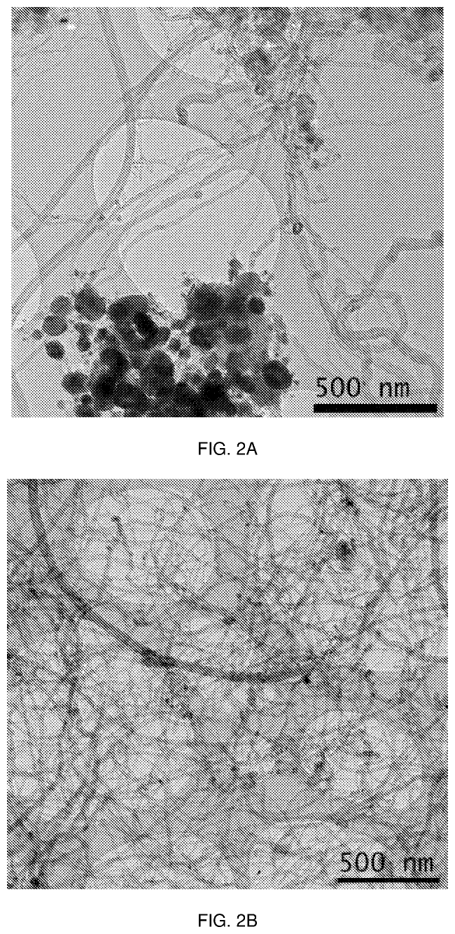

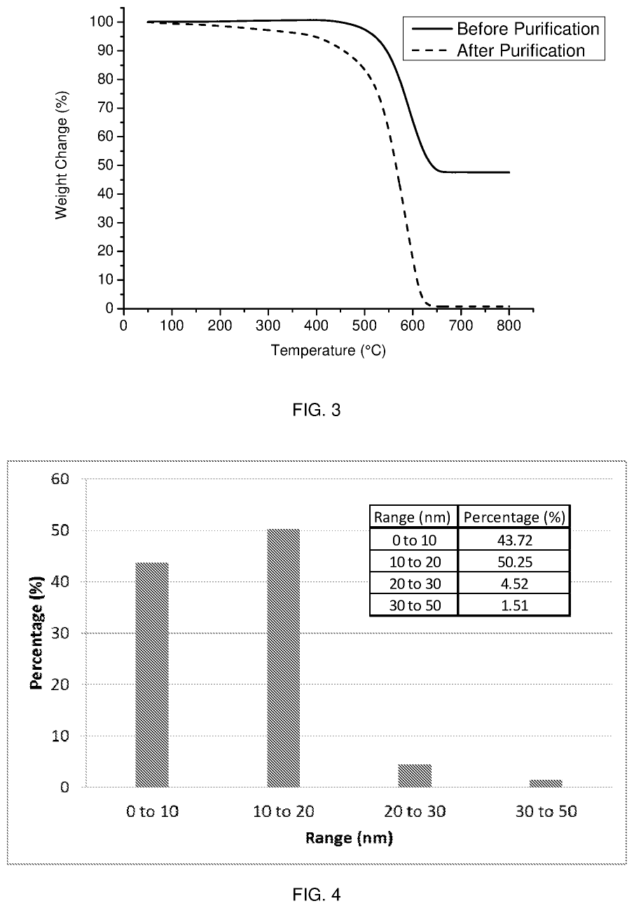

Referring now to FIGS. 2A, 2B and 3, the total removal of the catalysts from the carbon nanotubes are validated with the TEM images and thermal gravimetric analysis (TGA) results shown. Most catalysts represented by dark areas in FIG. 2A are shown to be removed using the hydrothermal acid method with optimal time and temperatures. The catalysts were observed in the TEM image before the treatment (see FIG. 2A), but not after the treatment (see FIG. 2B), suggesting a complete removal of the catalyst. A trace amount of metallic catalysts embedded in the nanotubes remained intact.

The same conclusion can also be gathered from the TGA results shown in FIG. 3 as the residue percentage decreases from about 50% to an almost negligible quantity. Given that all carbons, including carbon nanotubes, are burnt away during the thermal reaction process, the percentage amount of residue remaining should be equivalent to the percentage amount of catalysts remaining encapsulated in the carbon nanotubes. Accordingly, the TGA results also suggest a complete removal of the catalyst content.

Table 1 below shows the percentage amount of residue remaining as analysed by TGA for various samples of carbon nanotubes obtained from different purification methods under different conditions. The residue was measured using TGA after various acid treatments. The hydrothermal treatment was carried out in an acid digester.

TABLE 1

| | | 5M | 5M | 5M | 2M | 1M |
|---|---|---|---|---|---|---|
| | | HCl | H₂SO₄ | HNO₃ | HNO₃ | HNO₃ |
| Reflux | 25° C. (24 h) | 29% | 35% | 39% | X | X |
| | 60° C. (24 h) | 25% | 30% | 28% | X | X |
| | 100° C. (24 h) | 27% | 24% | 5% | X | X |
| | 120° C. (24 h) | 11% | 6% | X | X | X |
| Hydro- | 140° C. (2 h) | 35% | 47% | 41% | X | X |
| thermal | 140° C. (6 h) | 17% | 6% | 6% | X | X |
| | 140° C. (8 h) | 10% | 5% | 5% | 10% | 26% |
| | 140° C. (12 h) | 9% | 5% | 2% | X | X |
| | 160° C. (4 h) | X | X | 2% | X | X |

X indicates that the experiment was not performed.

From Table 1 above, it can be concluded that hydrothermal treatment with nitric acid at 140° C. for 6 hours will have similar results as compared to that of refluxing at 100° C. for 24 hours. This shows that the duration of the purification process may be reduced by four (4) fold to obtain similar results. The experiments also demonstrate that all three (3) acids tested can effectively remove catalyst when used in a hydrothermal treatment process at 140° C. for 8 hours.

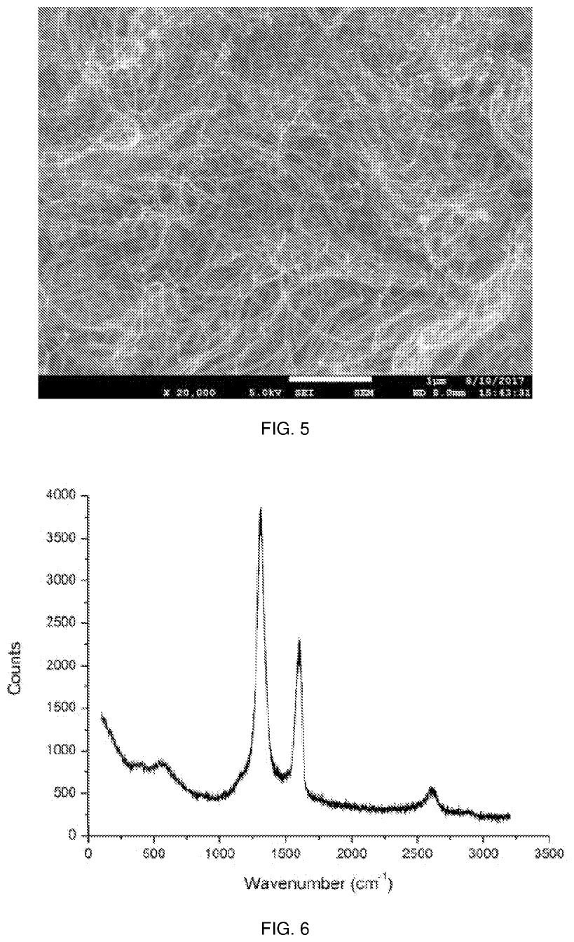

Referring now to FIGS. 4 through 6, the remaining characterization results for the purified carbon nanotubes that were obtained are shown. As can be seen from the characterization results, the catalysts had been successfully removed. The outer diameter of the purified carbon nanotubes is typically in the range of 10-20 nanometres (nm) with 7-25 wall layers.

As is evident from the foregoing discussion, the present invention provides a carbon purification method that requires a shorter treatment time and uses a lower concentration of acid. The carbon purification method of the present invention may be used to remove 99 mass percent (wt %) of the catalyst. The present invention provides an efficient purification method for assynthesized carbon nanotubes through hydrothermal acid digestion or hydrothermal acid treatment. The method may be used for full separation or a complete removal of catalysts from carbon nanotubes. The method may be used to purify carbon nanotubes grown from natural rubber precursors or other hydrocarbon precursors from the catalyst.

While preferred embodiments of the invention have been described, it will be clear that the invention is not limited to the described embodiments only. Numerous modifications, changes, variations, substitutions and equivalents will be apparent to those skilled in the art without departing from the scope of the invention as described in the claims. The carbon purification method of the present invention may be applied to separation of carbon nanotubes with catalyst and purification of high quality carbon nanotubes.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A carbon purification method, comprising:
providing a carbon product having a catalyst content and/or impurities;
performing a hydrothermal acid digestion operation on the carbon product in an acid to dissolve the catalyst content and/or the impurities; and
performing a filtering operation to separate the dissolved catalyst content and/or the dissolved impurities from the carbon product.

2. The carbon purification method according to claim 1, wherein the hydrothermal acid digestion operation is performed in the acid at a temperature that is higher than a boiling point of the acid.

3. The carbon purification method according to claim 2, wherein the temperature at which the hydrothermal acid digestion operation is performed is between about 130 degrees Celsius (° C.) and about 160° C.

4. The carbon purification method according to claim 1, wherein the hydrothermal acid digestion operation is performed without addition of an oxidant.

5. The carbon purification method according to claim 1, wherein the hydrothermal acid digestion operation is performed at a pressure of between about 270,000 pascal (Pa) and about 650,000 Pa.

6. The carbon purification method according to claim 1, wherein the hydrothermal acid digestion operation is performed in an acid solution having a concentration of between about 1 mole per litre (mol/L) and about 5 mol/L.

7. The carbon purification method according to claim 1, wherein the catalyst content comprises one or more of a metal and a metal oxide.

8. The carbon purification method according to claim 7, wherein the catalyst content comprises one or more of iron (Fe), nickel (Ni), aluminium oxide (Al₂O₃) and nickel aluminium oxide (NiAl₂O₄).

9. The carbon purification method according to claim 1, wherein the hydrothermal acid digestion operation is performed for a period of between about 2 hours (h) and about 12 h.

10. The carbon purification method according to claim 1, wherein the carbon product is a plurality of carbon nanotubes.

11. The carbon purification method according to claim 10, wherein the carbon nanotubes are grown from natural rubber precursors or hydrocarbon precursors.

12. The carbon purification method according to claim 1, wherein between about 95 mass percent (wt %) and about 99 wt % of the catalyst content is removed.

13. A carbon product produced in accordance with the carbon purification method of claim 1, wherein the catalyst content of the carbon product is less than 5 wt %.
